(19) United States
(12) Patent Application Publication
(10) Pub. No.: US 2017/0163792 A1
(43) Pub. Date: Jun. 8, 2017

(54) METHOD, ELECTRONIC DEVICE and SYSTEM FOR DATA BACK TRANSMISSION AFTER LOSS OF MOBILE TERMINAL

(71) Applicants: Le Holdings (Beijing) Co., Ltd., Beijing (CN); Lemobile Information Technology (Beijing) Co., Ltd., Beijing (CN)

(72) Inventor: Tiancheng Tong, Beijing (CN)

(73) Assignees: Le Holdings (Beijing) Co., Ltd., Beijing (CN); Lemobile Information Technology (Beijing) Co., Ltd ., Beijing (CN)

(21) Appl. No.: 15/245,047

(22) Filed: Aug. 23, 2016

Related U.S. Application Data
(63) Continuation of application No. PCT/CN2016/088530, filed on Jul. 5, 2016.

(30) Foreign Application Priority Data
Dec. 8, 2015 (CN) 201510901123.7

(51) Int. Cl. H04M 1/725; H04W 12/02

(52) U.S. Cl. CPC H04M 1/72577; H04W 12/02

(57) ABSTRACT

The present invention discloses a method, electronic device and system for back transmission of data after a mobile terminal is lost, wherein the method comprises: acquiring trigger information for characterizing that the mobile terminal is in a lost state; turning on a microphone of the mobile terminal according to the trigger information to acquire audio data of the surrounding environment; judging whether the volume of the audio data exceeds a preset audio threshold or not; recording the audio data in a first preset time length if it is determined that the volume of the audio data exceeds the preset audio threshold; judging whether a first network connection exists or not; and performing back transmission of the audio data through the first network connection if the first network connection exists.

### CROSS REFERENCE TO RELATED APPLICATIONS

This disclosure is a continuation of International Application No. PCT/CN2016/088530, filed on Jul. 5, 2016, which is based upon and claims priority to Chinese Patent Application No. 201510901123.7, filed on Dec. 8, 2015, titled “METHOD, DEVICE AND SYSTEM FOR BACK TRANSMISSION OF DATA AFTER MOBILE TERMINAL IS LOST”, and the entire contents of which are incorporated herein by reference.

### TECHNICAL FIELD

This disclosure relates to the field of mobile communication, particularly to a method, electronic device and system for back transmission of data after a mobile terminal is lost.

### BACKGROUND

A mobile terminal (e.g. a mobile phone) is a daily communication tool frequently used by a user at present, the disclosure of mobile terminals brings great convenience to the users, and meanwhile, the users are increasingly dependent on the mobile terminals, because the mobile terminals at present not only meet a communication function, but also store a lot of information therein by people, for example, communication book, customer list, work log and other information. With the popularization of disclosure and the diversification of functions of the mobile terminals, that a mobile terminal is lost or stolen not only brings financial losses to a user, but also brings troubles to the user due to loss of the information stored in the mobile terminal The prevention of a mobile terminal from being lost more relies on the safety protection awareness of the mobile terminal user.

In the prior art, there are also some tracking methods after a mobile terminal is lost, for example, tracing and positioning of the lost mobile terminal according to feedback signal intensities through signal comparison between a mobile terminal of the same model and the lost mobile terminal in a preset area. However, after a mobile terminal is lost, it is usually difficult for its user to determine the position where the mobile terminal is lost, or it is difficult to quickly get a mobile terminal of the same model. Therefore, in the case that the area where the mobile terminal is lost is uncertain, how to track the mobile terminal has become a problem to be solved imperatively.

### SUMMARY

This disclosure provides a method, electronic device and system for back transmission of data after a mobile terminal is lost, which can provide the reference basis for tracking a mobile terminal by characterizing the environment where the mobile terminal is located after the mobile terminal is lost.

One objective of the embodiments of this disclosure is to provide a method for back transmission of data after a mobile terminal is lost. The method includes: acquiring trigger information for characterizing that the mobile terminal is in a lost state; turning on a microphone of the mobile terminal according to the trigger information to acquire audio data of the surrounding environment; judging whether the volume of the audio data exceeds a preset audio threshold or not; recording the audio data in a first preset time length if it is determined that the volume of the audio data exceeds the preset audio threshold; judging whether a first network connection exists or not; and if the first network connection exists, performing back transmission of the audio data through the first network connection.

Preferably, if it is determined that the first network connection does not exist, establishment of the first network connection is awaited.

Furthermore, a second network connection is enabled if the first network connection does not exist after waiting for a second preset time length, and the audio data are transmitted back through the second network connection.

Furthermore, after acquiring the trigger information for characterizing that the mobile terminal is in a lost state, the method further includes: locking the mobile terminal according to the trigger information, so that the mobile terminal is not illegally operated and used.

Another objective of the embodiments of this disclosure is to provide a system for back transmission of data after a mobile terminal is lost. The system includes: a data receiving terminal sends trigger information for characterizing that the mobile terminal is in a lost state to a server; the server sends the trigger information to the mobile terminal when the mobile terminal is in a network connection state; the mobile terminal turns on a microphone of the mobile terminal according to the trigger information to record audio data with the volume exceeding a preset audio threshold in a first preset time length; if a first network connection exists between the mobile terminal and the server, then the mobile terminal sends the audio data to the server through the first network connection; and the server sends the audio data to the date receiving terminal

Furthermore, if the first network connection does not exist after the mobile terminal waits for a second preset time length, a second network connection is enabled and the audio data are sent to the server through the second network connection.

Another objective of the embodiments of this disclosure is to provide an electronic device, including: at least one processor, and a memory in communication connection with the at least one processor, where the memory stores instructions that can be executed by the at least one processor, and the instructions are executed by the at least one processor to enable the at least one processor to: acquire trigger information for characterizing that the mobile terminal is in a lost state; turn on a microphone of the mobile terminal according to the trigger information to acquire audio data of the surrounding environment; judge whether the volume of the audio data exceeds a preset audio threshold or not; record the audio data in a first preset time length if it is determined that the volume of the audio data exceeds the preset audio threshold; judge whether a first network connection exists or not; and perform back transmission of the audio data through the first network connection if the first network connection exists.

For the electronic device, if it is determined that the first network connection does not exist, then the establishment of the first network connection is awaited.

For the electronic device, a second network connection is enabled if the first network connection does not exist after waiting for a second preset time length, and the audio data are transmitted back through the second network connection.

The electronic device locks the mobile terminal according to the trigger information after the step of acquiring the trigger information for characterizing that the mobile terminal is in a lost state, so that the mobile terminal is not illegally operated and used.

Another objective of the embodiments of this disclosure is to provide a non-volatile computer storage medium storing computer executable instructions that, when executed by the electronic device, enable the electronic device to: acquire trigger information for characterizing that the mobile terminal is in a lost state; turn on a microphone of the mobile terminal according to the trigger information to acquire audio data of the surrounding environment; judge whether the volume of the audio data exceeds a preset audio threshold or not; record the audio data in a first preset time length if it is determined that the volume of the audio data exceeds the preset audio threshold; judge whether a first network connection exists or not; and perform back transmission of the audio data through the first network connection if the first network connection exists.

The non-volatile computer storage medium waits for establishment of the first network connection, if it is determined that the first network connection does not exist.

The non-volatile computer storage medium enables a second network connection if the first network connection does not exist after waiting for the second preset time length, and transmits back the audio data through the second network connection.

The non-volatile computer storage medium locks the mobile terminal according to the trigger information, after the step of acquiring the trigger information for characterizing that the mobile terminal is in a lost state, so that the mobile terminal is not illegally operated and used.

The method, electronic device and system for back transmission of data after a mobile terminal is lost, provided by the embodiments of this disclosure, record the audio data in a first preset time length when the volume of the acquired audio data of the surrounding environment exceeds a preset audio threshold, and transmit the audio data back through a first network connection, thus achieving back transmission of the audio data after the mobile terminal is lost. The audio data can characterize the environment of the mobile terminal to provide the reference basis for tracking the mobile terminal

As a preferred technical solution, the mobile terminal is locked according to the trigger information, so that the mobile terminal is not illegally operated and used, thereby preventing the mobile terminal from being unexpectedly operated and used, and improving the safety of private data of the mobile terminal.

### BRIEF DESCRIPTION OF DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a block diagram of structure of a system for back transmission of data after a mobile terminal is lost in accordance with embodiment 1 of this disclosure;

FIG. 2 is a schematic diagram of a time sequence of a system for back transmission of data after a mobile terminal is lost in accordance with embodiment 1 of this disclosure;

FIG. 3 is a flow diagram of a method for back transmission of data after a mobile terminal is lost in accordance with embodiment 2 of this disclosure;

FIG. 4 is a schematic diagram of a structure of a device for back transmission of data after a mobile terminal is lost in accordance with embodiment 2 of this disclosure; and

FIG. 5 is a schematic diagram of the hardware structure of an electronic device for back transmission of data after an executing mobile terminal is lost in accordance with embodiment 4 of this disclosure.

### DETAILED DESCRIPTION OF EMBODIMENTS

In order to make the objectives, technical solutions and advantages of the embodiments of this disclosure clearer, hereinafter, the technical solutions of this disclosure are clearly and completely described through implementation modes with reference to the drawings in the embodiments of this disclosure, and obviously, the described embodiments are part of the embodiments of this disclosure, rather than all the embodiments.

### Embodiment 1

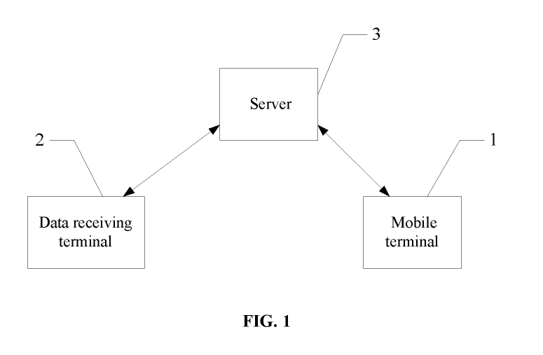

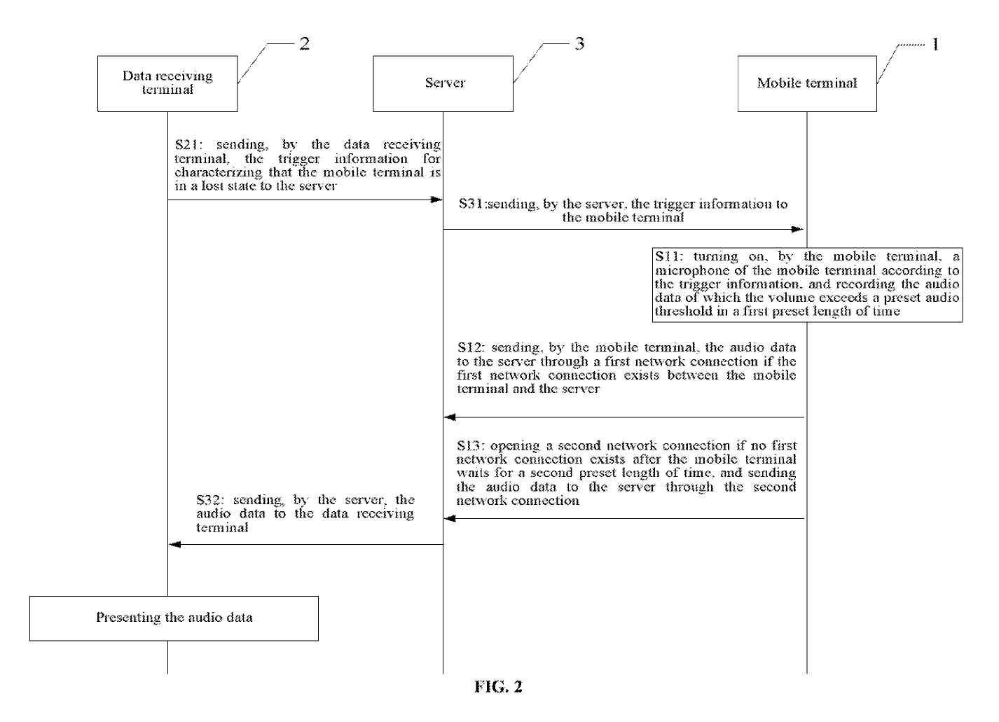

FIG. 1 is a schematic diagram of a system for back transmission of data after a mobile terminal is lost, disclosed by the present embodiment. After a mobile terminal 1 is lost, a user can acquire the data transmitted back by the mobile terminal 1 by using a data receiving terminal 2. The system for back transmission of data after the mobile terminal is lost includes the data receiving terminal 2 and a server 3. FIG. 2 is a schematic diagram of a time sequence of the system for back transmission of data after the mobile terminal is lost. Hereinafter, the system for back transmission of data after a mobile terminal is lost, disclosed by the present embodiment, is described in conjunction with FIG. 1 and FIG. 2:

Step S21: the data receiving terminal 2 sends the trigger information for characterizing that the mobile terminal 1 is in a lost state to the server 3. In a specific embodiment, the sent trigger information shall at least include a control command with related operations which can be executed by the mobile terminal 1. Certainly, the trigger information may also include semantic information, such as text information, image information, voice information, etc. In a specific embodiment, the data receiving terminal 2 may be a mobile phone, a tablet computer, a computer and other equipment which can be networked with the server 3. It should be noted that, in a specific implementation, a user can bind an account number with his multiple terminals 1, select one of the mobile terminals 1 from the bound account number when the mobile terminal 1 is lost and sends the trigger information of the lost mobile terminal 1 to the server 3 by using the data receiving terminal 2.

Step S31: the server 3 sends the trigger information to the mobile terminal 1 when the mobile terminal 1 is in a networking state. It should be noted that, in order to realize communication between the mobile terminal 1 and the server 3, the mobile terminal 1 should be in a networking state, and specifically, the networking may be realized by a mobile network, or by wireless networks of WiFi, etc.

Step S11: the mobile terminal 1 turns on a microphone of the mobile terminal according to the trigger information to record audio data, the volume of which exceeds a preset audio threshold in a first preset time length. In a specific embodiment, the preset audio threshold may be preset in the mobile terminal as a matter of experience, or may be set in the data receiving terminal 2 by the user, is carried by the trigger information and is sent to the mobile terminal 1. The recorded audio data may be stored in a storage unit of the mobile terminal.

Step S12: the mobile terminal 1 sends the audio data to the server 3 through a first network connection if the first network connection exists between the mobile terminal 1 and the server 3. In the present embodiment, the first network connection may be a wireless communication network, such as WiFi, Bluetooth, etc.

Step S32: the server 3 sends the audio data to the data receiving terminal 2. So far, the data receiving terminal 2 may present the current environment of the mobile terminal 1 to the user according to the received audio data.

Generally, no first network connection exists in a possible environment of the mobile terminal 1, and in order not to influence the back transmission of data of the mobile terminal 1, in a preferred embodiment, the system for back transmission of data after the mobile terminal is lost may further include the following steps:

Step S13: a second network connection is enabled if no first network connection exists after the mobile terminal 1 waits for a second preset time length, and the audio data are sent to the server 3 through the second network connection. In a specific embodiment, the second preset time length may be judged as a matter of experience and is usually not too long to prevent the mobile terminal from being unexpectedly moved. In the present embodiment, the second network connection may be a mobile network of an operator of the mobile terminal, for example, China Mobile, China Telecom, China Unicom, etc., and certainly, the second network connection may also be a mobile network provided by an operator from other countries or regions.

The system for back transmission of data after the mobile terminal is lost, provided by the embodiments of the present invention, records the audio data in a first preset time length when the volume of the acquired audio data of the surrounding environment exceeds a preset audio threshold, and transmits the audio data back through a first network connection, thus realizing back transmission of the audio data after the mobile terminal is lost. The audio data can characterize the environment of the mobile terminal to provide the reference basis for tracking the mobile terminal.

As a preferred technical solution, the second network connection is adopted to send the audio data to the server when the first network connection does not exist, thereby further ensuring the promptness of back transmission of the audio data.

### Embodiment 2

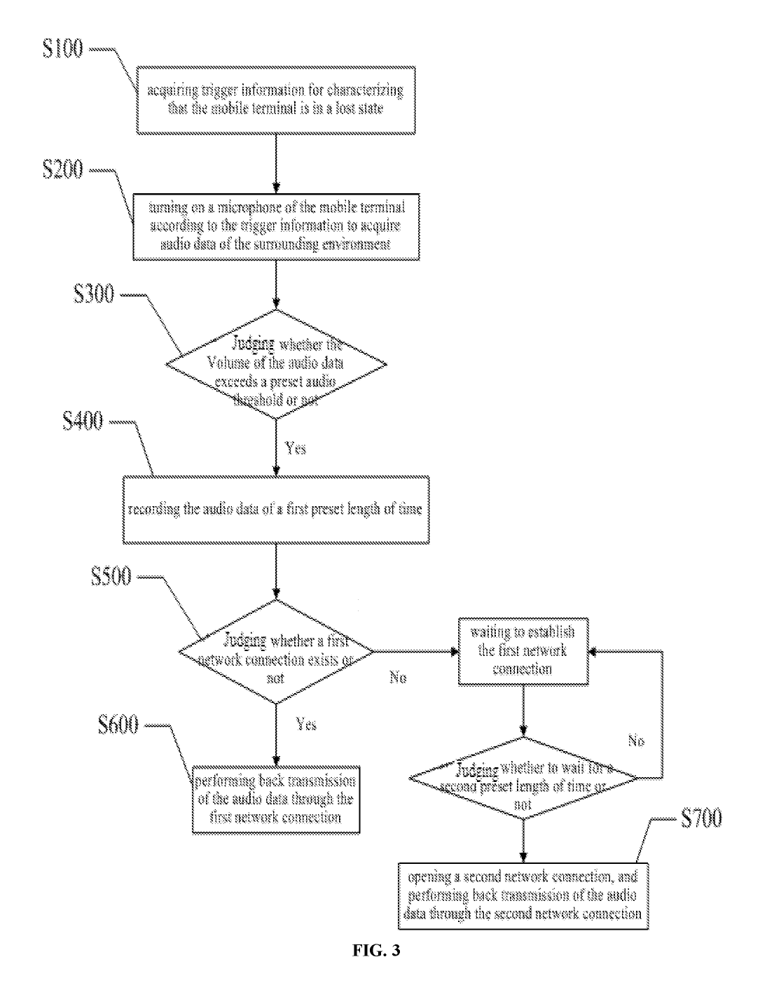

FIG. 3 is a flow diagram of a method for back transmission of data after a mobile terminal is lost, disclosed by the present embodiment. The method for back transmission of data after the mobile terminal is lost includes the following steps:

Step S100: trigger information for characterizing that the mobile terminal is in a lost state is acquired. In a specific embodiment, the acquired trigger information shall at least include a control command with related operations which can be executed by the mobile terminal, and certainly, the trigger information may also include semantic information, such as text information, image information, voice information, etc.

Step S200: a microphone of the mobile terminal is turned on according to the trigger information to acquire audio data of the surrounding environment. In a specific embodiment, after acquiring the trigger information, the microphone can be kept in an on state to acquire the audio data of the surrounding environment in real time, thereby monitoring audio information of the surrounding environment in real time.

Step S300: whether the volume of the audio data exceeds a preset audio threshold or not is judged. In a specific embodiment, the preset audio threshold may be preset in the mobile terminal as a matter of experience, or may also be set in a data receiving terminal by a user, is carried by the trigger information and is transmitted to the mobile terminal Step S400 will be executed if it is determined that the volume of the audio data exceeds the preset audio threshold, or, the audio data will be further acquired if it is determined that the volume of the audio data does not exceed the preset audio threshold.

Step S400: the audio data in a first preset time length is recorded. The first preset time length may be judged as a matter of experience, may be preset in the mobile terminal, or may be set in the data receiving terminal by the user, is carried by the trigger information, and is transmitted to the mobile terminal. In the present embodiment, the recorded audio data may be stored in a storage unit of the mobile terminal.

Step S500: whether a first network connection exists or not is judged. In the present embodiment, the first network connection may be realized by WiFi, Bluetooth or other wireless communication networks. Generally, a first network access point around will be searched automatically when the switch of the first network connection (for example, WiFi) is switched on. Step S600 will be executed if the first network connection exists.

Step S600: back transmission of the audio data is performed through the first network connection. Therefore, the audio data of the surrounding environment of the mobile terminal are transmitted back to a data receiving terminal specified by a user.

In a specific embodiment, establishment of the first network connection is awaited if it is determined that the first network connection does not exist in step S500. In a preferred embodiment, step S700 will be executed if the first network connection does not exist after waiting for a second preset time length.

Step S700: a second network connection is enabled, and back transmission of the audio data is performed through the second network connection. In a specific embodiment, the second preset time length may be judged as a matter of experience, and is usually not too long to prevent the mobile terminal from being unexpectedly moved. In the present embodiment, the second network connection may be a mobile network of an operator of the mobile terminal, for example, China Mobile, China Telecom, China Unicom, etc., and certainly, the second network connection may also be a mobile network provided by an operator from other countries or regions.

In order to prevent the mobile terminal from being unexpectedly operated and used, the safety of private data of the mobile terminal is improved. In a preferred embodiment, the method further includes, after acquiring the trigger information for characterizing that the mobile terminal is in a lost state: locking the mobile terminal according to tracking information, so that the mobile terminal is not illegally operated and used. In the present embodiment, the execution order between this step and step S200 is not limited.

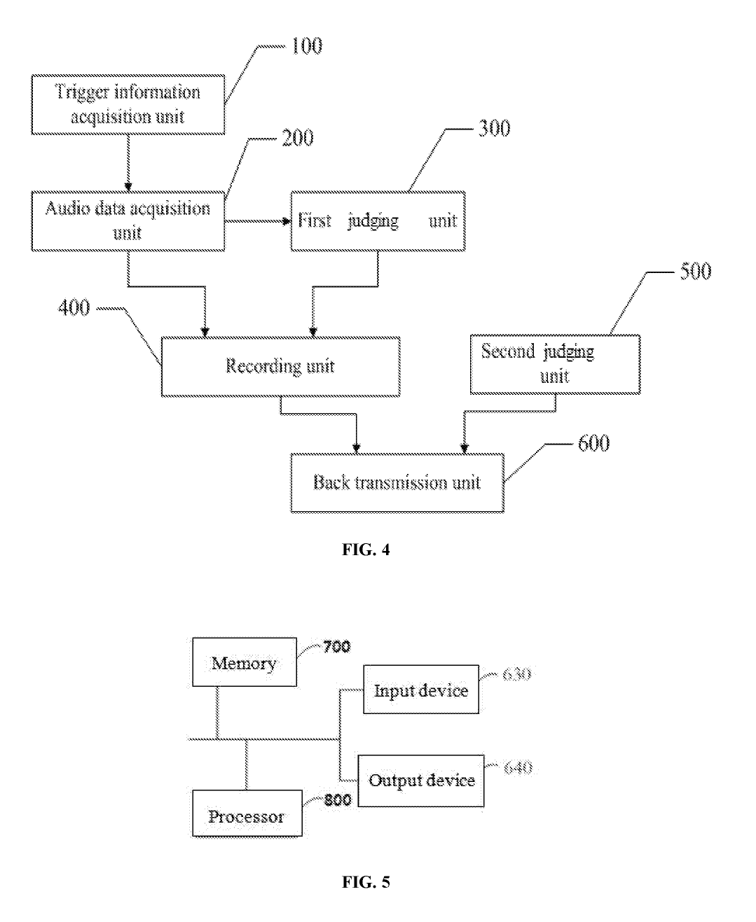

The present embodiment further discloses a device for back transmission of data after a mobile terminal is lost, as shown in FIG. 4. The device for back transmission of data after a mobile terminal is lost includes the following units: a trigger information acquisition unit 100, an audio data acquisition unit 200, a first judging unit 300, a recording unit 400, a second judging unit 500, and a back transmission unit 600, where,

the trigger information acquiring unit 100 is used for acquiring trigger information for characterizing that the mobile terminal is in a lost state; the audio data acquisition unit 200 is used for turning on a microphone of the mobile terminal according to the trigger information to acquire audio data of the surrounding environment; the first judging unit 300 is used for judging whether the volume of the audio data exceeds a preset audio threshold or not; the recording unit 400 is used for recording the audio data in a first preset time length if it is determined that the volume of the audio data exceeds the preset audio threshold; the second judging unit 500 is used for judging whether a first network connection exists or not; and the back transmission unit 600 is used for back transmission of the audio data through the first network connection if the first network connection exists.

In a preferred embodiment, if it is determined that the first network connection does not exist, establishment of the first network connection is awaited.

In a preferred embodiment, the device for back transmission of data after the mobile terminal is lost further includes a second network establishing unit, for enabling a second network connection if the first network connection does not exist after waiting for a second preset time length, and transmitting the audio data back through the second network connection.

In a preferred embodiment, the device for back transmission of data after the mobile terminal is lost further includes a locking unit, for locking the mobile terminal according to the trigger information, so that the mobile terminal is not illegally operated and used.

The method and device for back transmission of data after the mobile terminal is lost, provided by the embodiment of this disclosure, record the audio data in a first preset time length when the volume of the acquired audio data of the surrounding environment exceeds a preset audio threshold, and transmit the audio data back through a first network connection, thus realizing back transmission of the audio data after the mobile terminal is lost. The audio data can characterize the environment of the mobile terminal to provide the reference basis for tracking the mobile terminal.

In a preferred embodiment, when the first network connection still does not exist after waiting for a second preset time length, a second network connection is adopted for back transmission of data, so as to improve the promptness of back transmission of audio data.

In a preferred embodiment, the mobile terminal is locked according to the trigger information, so that the mobile terminal is not illegally operated and used, thereby preventing the mobile terminal from being operated and used unexpectedly, and enhancing the security of private data of the mobile terminal.

### Embodiment 3

The present embodiment provides a non-volatile computer storage medium storing computer executable instructions for executing the method for back transmission of data after the mobile terminal is lost in accordance with any one of the abovementioned embodiments of the method.

The non-volatile computer storage medium stores the computer executable instructions that, when executed by the electronic device, enable the electronic device to: acquire trigger information for characterizing that the mobile terminal is in a lost state; turn on a microphone of the mobile terminal according to the trigger information to acquire audio data of the surrounding environment; judge whether the volume of the audio data exceeds a preset audio threshold or not; record the audio data in a first preset time length if it is determined that the volume of the audio data exceeds the preset audio threshold; judge whether a first network connection exists or not; and perform back transmission of the audio data through the first network connection if the first network connection exists.

The non-volatile computer storage medium waits for establishment of the first network connection, if it is determined that the first network connection does not exist.

The non-volatile computer storage medium enables a second network connection if the first network connection does not exist after waiting for a second preset time length, and transmits the audio data back through the second network connection.

The non-volatile computer storage medium locks the mobile terminal according to the trigger information after the step of acquiring the trigger information for characterizing that the mobile terminal is in a lost state, so that that the mobile terminal is not illegally operated and used.

### Embodiment 4

FIG. 5 is a schematic diagram of a structure of hardware of the electronic device for executing the method for back transmission of data after the mobile terminal is lost in accordance with an embodiment of this disclosure, and as shown in FIG. 5, the device includes one or more processors 800 and a memory 700, and one processor 800 is taken as an example in FIG. 5; and the electronic device for executing A method for back transmission of data after a mobile terminal is lost, may also include: an input device 630 and an output device 640.

The processor 800, the memory 700, the input device 630 and the output device 640 may be connected with a bus or in other ways, and bus connection is taken as an example in FIG. 5.

The memory 700, as a non-volatile computer readable storage medium, may be used for storing non-volatile software programs, non-volatile computer executable programs and modules, such as the program instructions/modules (e.g., a trigger information acquisition unit 100, an audio data acquisition unit 200, a first judging unit 300, a recording unit 400, a second judging unit 500 and a back transmission unit 600 shown in FIG. 4) corresponding to the method for back transmission of data after the mobile terminal is lost in the embodiments of this disclosure. The processor 800 runs the non-volatile software programs, instructions and modules stored in the memory 700, so as to execute various functional applications and data processing of a server, namely implementing the method for back transmission of the data after the mobile terminal is lost in the abovementioned embodiments of the method.

The memory 700 may include a program storage area and a data storage area, where the program storage area may store an operating system and applications required for at least one function; and the data storage area may store data and the like created according to the use of a multimedia photo generation device. Moreover, the memory 700 may include a high-speed random access memory, and may also include a non-volatile memory, such as at least one disk storage device, a flash memory, or other non-volatile solid storage devices. In some embodiments, the memory 700 optionally includes memories that are set remotely relative to the processor 800, and these remote memories may be connected through a network to the device for back transmission of the data after the mobile terminal is lost. An example of the network includes, but is not limited to, internet, intranet, LAN, mobile communication network, and the combinations thereof.

The input device 630 may receive input digit or character information, so as to generate a key signal input related to the user configuration and function control of the device for back transmission of the data after the mobile terminal is lost. The output device 640 may include display devices such as a display screen.

The one or more modules are stored in the memory 700, and when executed by the one or more processors 800, perform the method for back transmission of data after the mobile terminal is lost in any one of the abovementioned embodiments of the method.

The abovementioned product can perform the method provided by the embodiments of this disclosure and have corresponding functional modules for executing the method and beneficial effects. For more technical details of this embodiment, please refer to the method provided by the embodiments of this disclosure.

The electronic device of the embodiments of this disclosure can exist in many forms, including but not limited to the following devices:

(1) Mobile communication devices: the characteristic of such devices are that they have a mobile communication function, and mainly aim to provide voice and data communication. Such terminals include: smart phones (such as iPhone), multimedia phones, feature phones, low-end phones, etc.

(2) Ultra-mobile personal computer devices: such devices belong to the category of personal computers, have computing and processing functions and usually also have mobile internet access features. Such terminals include: PDA, MID, UMPC devices, etc., such as iPad.

(3) Portable entertainment devices: such devices are able to display and play multimedia contents. Such devices include: audio and video players (such as iPod), handheld game players, electronic books, smart toys, and portable vehicle navigation devices.

(4) Servers: devices providing computing services. The structure of a server includes a processor, hard disks, an internal memory, a system bus, etc. Structures of the servers are similar to that of a general purpose computer, but because of the need of providing highly reliable services, the server has high requirements in aspects of processing capability, stability, reliability, security, expandability, manageability, etc.

(5) Other electronic devices having data interaction function.

The embodiments of the abovementioned device are only illustrative, where the units described as separate parts may be or may not be physically separated, the components shown as units may be or may not be physical units, i.e. may be located in one place, or may be distributed to multiple network units. According to actual needs, part of or all of the modules therein are selected to realize the objectives of the solution of the embodiment.

By descriptions of the abovementioned implementations, those skilled in the art can clearly understand that various embodiments may be implemented by software and a general hardware platform, and of course, may also be implemented by hardware. Based on such understanding, the abovementioned technical solution may be essentially reflected, or the part thereof making contribution to related technology may be reflected in the form of a software product, and such computer software product may be stored in a computer readable storage medium such as an ROM/RAM, a magnetic disk or an optical disk, etc., and may include a plurality of instructions to enable a computer device (which may be a personal computer, a server, or a network device, etc.) to execute the methods described in various embodiments or in some parts thereof.

Finally, it should be noted that: the abovementioned embodiments are merely illustrated for describing rather than limiting the technical solution of this disclosure; although detailed description of this disclosure is given with reference to the abovementioned embodiments, those skilled in the art should understand that they still can modify the technical solutions recorded in the various abovementioned embodiments or replace part of the technical features therein with equivalents; and these modifications or replacements would not cause the essence of the corresponding technical solutions to depart from the spirit and scope of the technical solutions of the various embodiments of this disclosure.

1. A method for back transmission of data after a mobile terminal is lost, comprising:
acquiring trigger information for characterizing that the mobile terminal is in a lost state;
turning on a microphone of the mobile terminal according to the trigger information to acquire audio data of the surrounding environment;
judging whether the volume of the audio data exceeds a preset audio threshold or not;
recording the audio data in a first preset time length if it is determined that the volume of the audio data exceeds the preset audio threshold;
judging whether a first network connection exists or not; and
performing back transmission of the audio data through the first network connection if the first network connection exists.

2. The method for back transmission of data after the mobile terminal is lost according to claim 1, wherein if it is determined that the first network connection does not exist, establishment of the first network connection is awaited.

3. The method for back transmission of data after the mobile terminal is lost according to claim 2, wherein a second network connection is enabled if the first network connection does not exist after waiting for a second preset time length, and the audio data are transmitted back through the second network connection.

4. The method for back transmission of data after the mobile terminal is lost according to claim 1, further comprising after the step of acquiring the trigger information for characterizing that the mobile terminal is in a lost state: locking the mobile terminal according to the trigger information, so that the mobile terminal is not illegally operated and used.

5. The electronic device according to claim 7, wherein the electronic device forms part of a system for back transmission of data after the mobile terminal is lost, wherein the system comprises:
a data receiving terminal sends trigger information for characterizing that a mobile terminal is in a lost state to a server;
the server sends the trigger information to the mobile terminal when the mobile terminal is in a network connection state;
the mobile terminal turns on a microphone of the mobile terminal according to the trigger information to record audio data, volume of which in a first preset time length exceeds a preset audio threshold;
if a first network connection exists between the mobile terminal and the server, then the mobile terminal sends the audio data to the server through the first network connection; and
the server sends the audio data to the date receiving terminal

6. The electronic device according to claim 5, wherein if the first network connection does not exist after the mobile terminal waits for a second preset time length, a second network connection is enabled and the audio data are sent to the server through the second network connection.

7. An electronic device, comprising: at least one processor; and a memory in communication connection with the at least one processor; wherein the memory stores instructions that can be executed by the at least one processor, and the instructions are executed by the at least one processor to enable the at least one processor to:
acquire trigger information for characterizing that the mobile terminal is in a lost state;
turn on a microphone of the mobile terminal according to the trigger information to acquire audio data of the surrounding environment;
judge whether the volume of the audio data exceeds a preset audio threshold or not;
record the audio data in a first preset time length if it is determined that the volume of the audio data exceeds the preset audio threshold;
judge whether a first network connection exists or not; and
perform back transmission of the audio data through the first network connection if the first network connection exists.

8. The electronic device according to claim 7, wherein if it is determined that the first network connection does not exist, establishment of the first network connection is awaited.

9. The electronic device according to claim 8, wherein a second network connection is enabled if the first network connection does not exist after waiting for a second preset time length, and the audio data are transmitted back through the second network connection.

10. The electronic device according to claim 7, wherein after the step of acquiring the trigger information for characterizing that the mobile terminal is in a lost state, the mobile terminal is locked according to the trigger information, so that the mobile terminal is not illegally operated and used.

11. A non-volatile computer storage medium, storing computer executable instructions, that, when executed by the electronic device, enable the electronic device to:
acquire trigger information for characterizing that the mobile terminal is in a lost state;
turn on a microphone of the mobile terminal according to the trigger information to acquire audio data of the surrounding environment;
judge whether the volume of the audio data exceeds a preset audio threshold or not;
record the audio data in a first preset time length if it is determined that the volume of the audio data exceeds the preset audio threshold;
judge whether a first network connection exists or not; and
perform back transmission of the audio data through the first network connection if the first network connection exists.

12. The non-volatile computer storage medium according to claim 11, wherein if it is determined that the first network connection does not exist, establishment of the first network connection is awaited.

13. The non-volatile computer storage medium according to claim 12, wherein a second network connection is established if the first network connection does not exist after waiting for a second preset time length, and the audio data are transmitted back through the second network connection.

14. The non-volatile computer storage medium according to claim 11, wherein after the step of acquiring the trigger information for characterizing that the mobile terminal is in a lost state, the mobile terminal is locked according to the trigger information, so that the mobile terminal is not illegally operated and used.
